(19) United States
(12) Patent Application Publication
(10) Pub. No.: US 2013/0252469 A1
(43) Pub. Date: Sep. 26, 2013

(54) CONNECTION STRUCTURE AND CONNECTION UNIT OF ELETRONIC COMPONENT

(71) Applicant: YAZAKI CORPORATION, Tokyo (JP)

(72) Inventor: Shinji MOCHIZUKI, Shizuoka (JP)

(73) Assignee: YAZAKI CORPORATION, Tokyo (JP)

(21) Appl. No.: 13/894,239

(22) Filed: May 14, 2013

Related U.S. Application Data
(63) Continuation of application No. PCT/JP2011/079128, filed on Dec. 9, 2011.

(30) Foreign Application Priority Data
Dec. 22, 2010 (JP) 2010-286244

(51) Int. Cl. H01R 13/514

(52) U.S. Cl. CPC H01R 13/514
USPC 439/626

(57) ABSTRACT

A connection structure includes: a box-shaped housing having a bottom wall and side walls which extend from the bottom wall; an electronic component which is accommodated inside the housing; and a pair of terminals, being the same in shape, which are inserted into the housing vertically along planes of two side walls and placed on a placement surface of the bottom wall to be fixed inside the housing. Each terminal includes: a component-connection portion which is formed at a first end of the terminal to be electrically connected to the electronic component; and a press-contact terminal portion which is formed at a second end opposite to the first end and which has a notch to which an electric wire is to be press-fitted and electrically connected, wherein a surface in which the notch is formed extends in parallel to the placement surface of the bottom wall of the housing.

### CROSS REFERENCE TO RELATED APPLICATIONS

This application is a continuation of PCT application No. PCT/JP2011/079128, which was filed on Dec. 9, 2011 based on Japanese Patent Application (No. 2010-286244) filed on Dec. 22, 2010, the contents of which are incorporated herein by reference.

### BACKGROUND OF THE INVENTION

1. Field of the Invention

The present invention relates to a connection structure and a connection unit which electrically connect an electronic component by a pair of terminals.

2. Description of the Related Art

A related art shows a connection structure of an electronic component (or an electronic-component connection structure) which electrically connects electronic components by a pair of terminals, and a connection unit in which the connection structure is assembled. Each terminal of the pair of terminals used in the electronic-component connection structure is accommodated in a housing so that a press-contact terminal portion having a notch formed on the plate-like material to which an electric wire is press-fitted is formed at one end of the terminal, and different electric wires are respectively connected to the press-contact terminals. The pair of terminals are arranged side by side to be accommodated in the housing to reduce waste of the space. In this case, one ends to which electronic components are connected are attached in the housing so that the end faces of the one ends are aligned (see JP-2007-149762A).

The electronic-component connection structure disclosed in JP-2007-149762A is an electronic-component connection structure which is used for an electronic device and includes a housing, and terminals provided in the housing and having press-contact blades disposed to face each other for being electrically connected with electronic components for circuit protection by pressing, and in which a positioning rib is formed for positioning lead portions of the electronic components, disposed adjacent to the press-contact blades, toward the press-contact blades.

### SUMMARY OF THE INVENTION

However, in the electronic-component connection structure disclosed in JP-2007-149762A, the pair of terminals is different in shape such that the press-contact terminal portions of the pair of terminals are misaligned to prevent that one of the terminals interferes with an electric wire of the other of the terminals. Thus, two types of terminals must be used, and manufacturing cost must be high.

The present invention has been made considering the problem, and an object of the present invention is to provide an electronic-component connection structure capable of reducing a manufacturing cost.

According to a first aspect of the present invention, there is provided a connection structure, including a box-shaped housing having a bottom wall and side walls which extend from the bottom wall; an electronic component which is accommodated inside the housing; and a pair of terminals, being the same in shape, which are inserted into the housing vertically along planes of two side walls which face each other among the side walls and placed on a placement surface of the bottom wall to be fixed inside the housing, each terminal of the pair of terminals including: a component-connection portion which is formed at a first end of the terminal to be electrically connected to the electronic component; and a press-contact terminal portion which is formed at a second end opposite to the first end of the terminal and which has a notch to which an electric wire is to be press-fitted and electrically connected, wherein a surface in which the notch is formed extends in parallel to the placement surface of the bottom wall of the housing.

A second aspect of the present invention provides the connection structure, wherein the pair of terminals is arranged within the housing so that the first ends of the pair of terminals are aligned in parallel to each other and the second ends of the pair of terminals are aligned in parallel to each other.

A third aspect of the present invention provides a connection unit in which the connection structure as mentioned above is assembled, the connection unit including: a unit housing having a box shape which is open on one surface from which the connection structure is accommodated inside the unit housing, wherein an opening portion is formed on an upper surface of the housing, the press-contact terminal portion of each terminal of the pair of terminals is exposed and extended outside the housing through the opening portion of the housing and provided perpendicularly from an outer surface of one of the side walls of the housing, and the press-contact terminal portion of each terminal of the pair of terminals is arranged at a side of the one surface on which the unit housing is open when the connection structure is accommodated in the unit housing.

A fourth aspect of the present invention provides the connection unit, further including; an electric-wire holding part in which two electric wires to be electrically connected to the pair of terminals are laterally bent and held; an engagement portion which engages the unit housing with the electric-wire holding part, wherein bent portions of the two electric wires which are held by the electric-wire holding part are electrically connected to the respective press-contact terminal portions of the pair of terminals when the unit housing and the electric-wire holding part are engaged by the engagement portion.

According to the electronic-component connection structure in the first aspect of the present invention, since the pair of terminals corresponds to the same shaped two terminals in which a surface in which the notch is formed extends in parallel to the placement surface of the bottom wall of the housing, even if the press-contact terminals portions are arranged side by side and the respective electric wires are press-fitted in the pair of terminals, one of the press-contact terminals does not interfere with the electric wire connected to the other of the press-contact terminals. Therefore, it is possible to unify the shape of the pair of terminals, thereby reducing the manufacturing cost.

Further, according to the electronic-component connection structure in the second aspect of the present invention, the pair of terminals is arranged within the housing so that the first ends of the pair of terminals are aligned in parallel to each other and the second ends of the pair of terminals are aligned in parallel to each other, that is, the pair of terminals are arranged so that their opposite ends are aligned. Therefore, it is possible to arrange the pair of terminals compactly.

Further, according to the electronic-component connection unit in the third aspect of the present invention, the connection unit includes a unit housing having a box shape which is open on one surface from which the connection structure is accommodated inside the unit housing. Further, an opening portion is formed on an upper surface of the housing, the press-contact terminal portion of each terminal of the pair of terminals is exposed and extended outside the housing through the opening portion of the housing and provided perpendicularly from an outer surface of one of the side walls of the housing, and the press-contact terminal portion of each terminal of the pair of terminals is arranged at a side of the one surface on which the unit housing is open when the connection structure is accommodated in the unit housing. Therefore, it is possible to accommodate the pair of terminals within the housing and the unit housing easily while the press-contact terminal portion is exposed.

Further, according to the electronic-component connection unit in the fourth aspect of the present invention, the connection unit further includes an electric-wire holding part in which two electric wires to be electrically connected to the pair of terminals are laterally bent and held, and an engagement portion which engages the unit housing with the electric-wire holding part. Bent portions of the two electric wires which are held by the electric-wire holding part are electrically connected to the respective press-contact terminal portions of the pair of terminals when the unit housing and the electric-wire holding part are engaged by the engagement portion. Therefore, since the electric wires are connected to the respective press-contact terminal portions while the electric wires are laterally bent, it is possible to save the space of the connection unit in the vertical direction.

### BRIEF DESCRIPTION OF THE DRAWINGS

FIG. 1 is an exploded perspective view illustrating a configuration of an LED lighting unit in which an electronic-component connection structure is assembled according to an embodiment of the present invention.

FIG. 2 is a top view of the LED lighting unit with an electric-wire holding part in FIG. 1 removed.

FIG. 3 is a cross-sectional view of the LED lighting unit shown in FIG. 2 as taken along line A-A.

FIG. 4 is a cross-sectional view of the LED lighting unit shown in FIG. 2 as taken along line B-B.

FIG. 5 is a bottom view of the electronic-component connection structure shown in FIG. 1.

FIG. 6 is an enlarged perspective view of a housing shown in FIG. 1.

FIG. 7 is a cross-sectional view illustrating a portion of the housing shown in FIG. 6.

FIG. 8 is an enlarged perspective view of a terminal shown in FIG. 1.

FIG. 9 is a diagram for explaining details of the electric-wire holding part shown in FIG. 1.

FIG. 10 is a circuit diagram illustrating a circuit configuration of the LED lighting unit shown in FIG. 1.

FIG. 11 is a diagram for illustrating an assembly procedure of the LED lighting unit in which the electronic-component connection structure is assembled according to the embodiment of the present invention.

FIG. 12 is a diagram for illustrating the assembly procedure of the LED lighting unit in which the electronic-component connection structure is assembled according to the embodiment of the present invention.

FIG. 13 is a diagram for illustrating the assembly procedure of the LED lighting unit in which the electronic-component connection structure is assembled according to the embodiment of the present invention.

FIG. 14 is a diagram for illustrating the assembly procedure of the LED lighting unit in which the electronic-component connection structure is assembled according to the embodiment of the present invention.

FIG. 15 is a diagram for illustrating the assembly procedure of the LED lighting unit in which the electronic-component connection structure is assembled according to the embodiment of the present invention.

### DETAILED DESCRIPTION OF THE EXEMPLARY EMBODIMENTS

Hereinafter, a connection structure of an electronic component (or an electronic-component connection structure) and a connection unit of an electronic component (or an electronic-component connection structure) according to an embodiment of the present invention will be described in detail with reference to the accompanying drawings.

### Embodiment

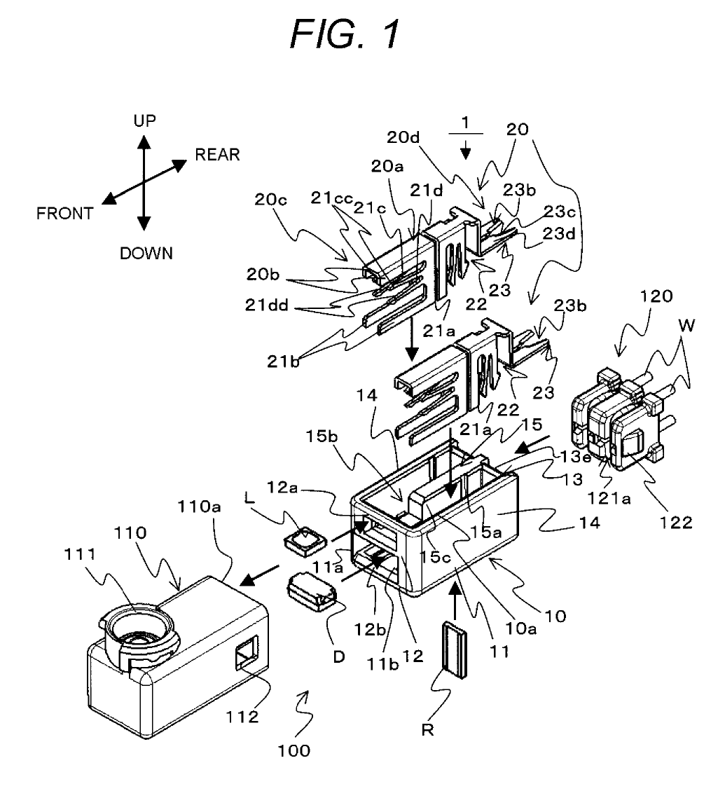

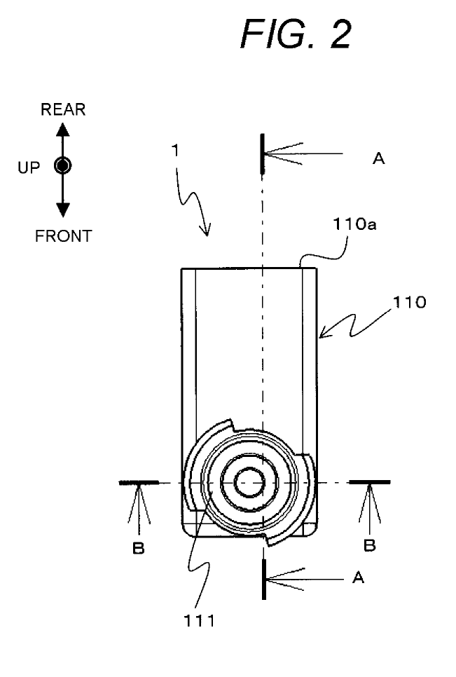

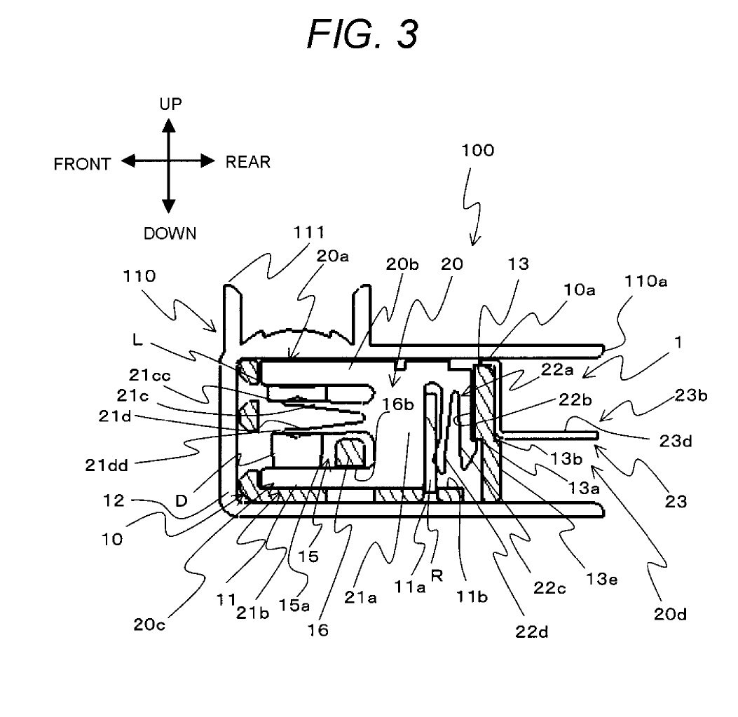

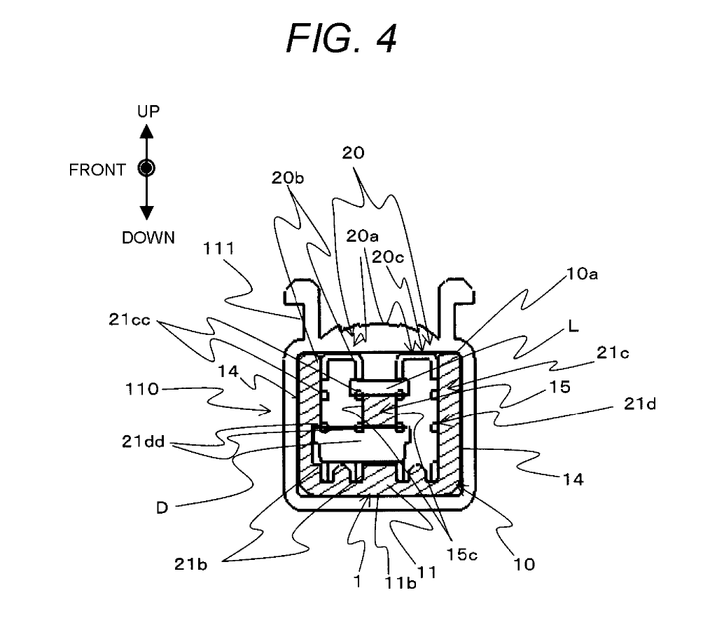

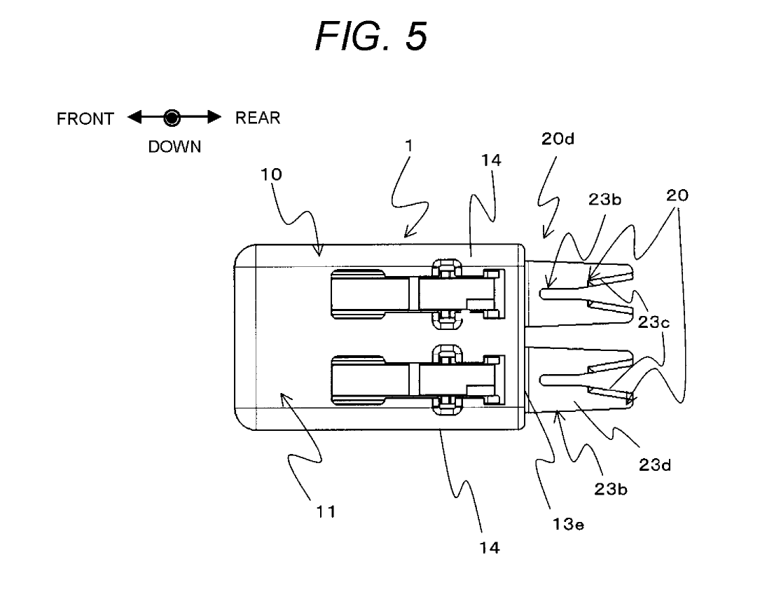

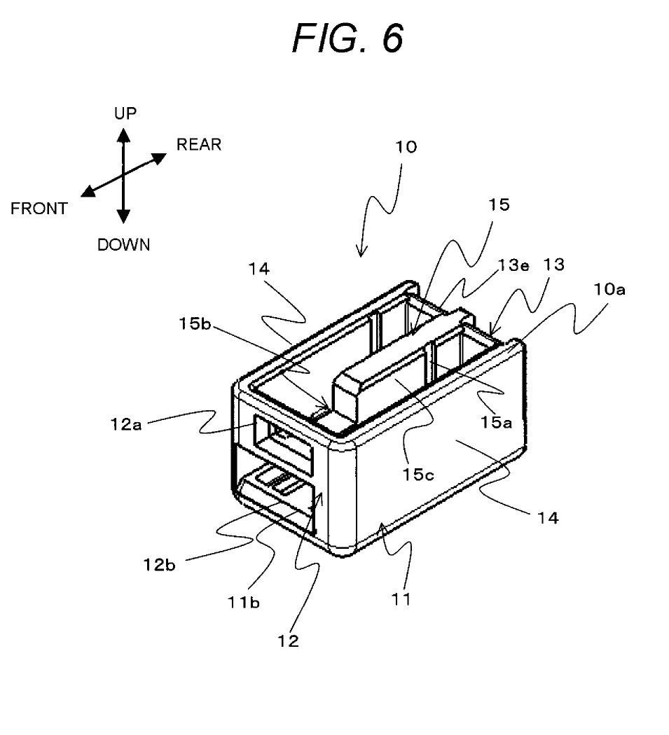

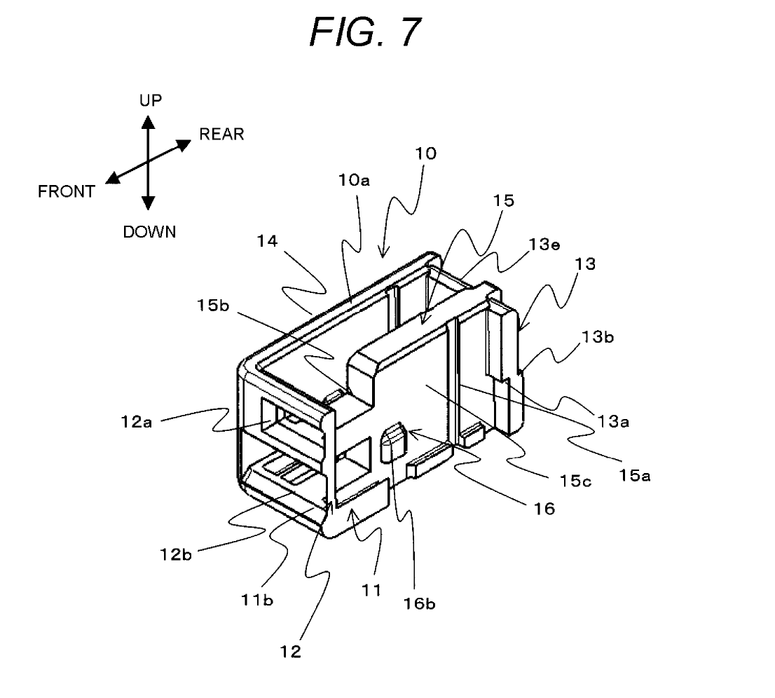

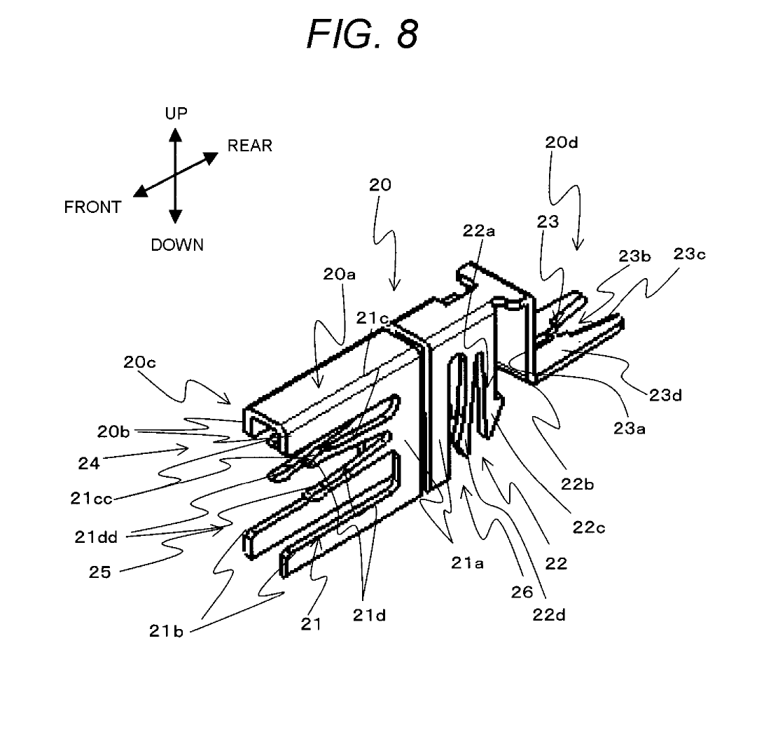

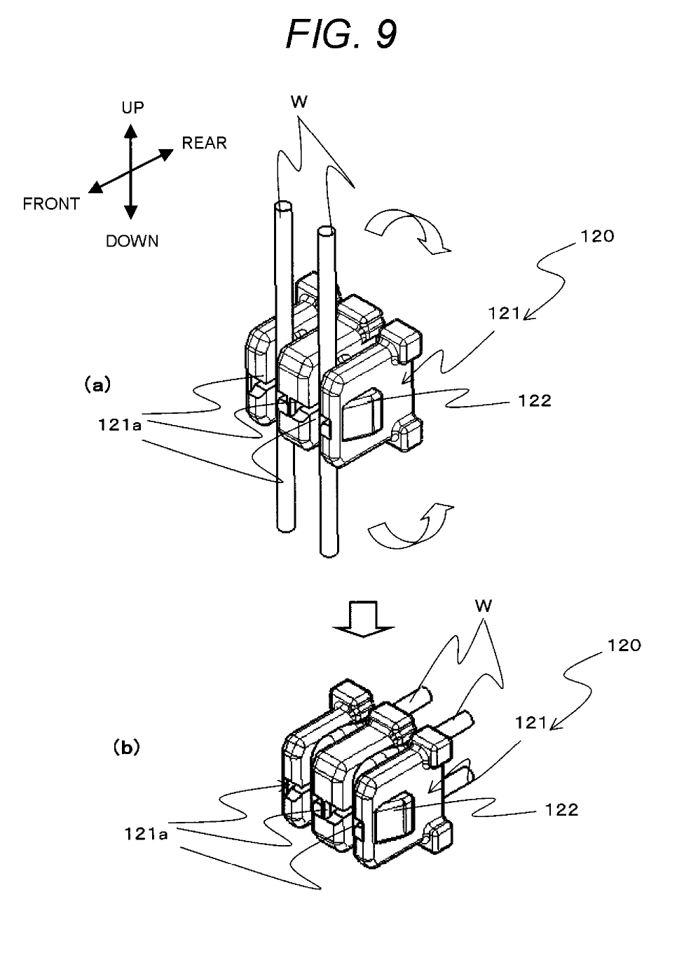

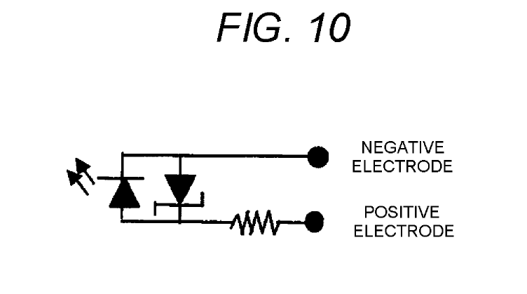

FIG. 1 is an exploded perspective view illustrating a structure of an LED lighting unit 100 in which an electronic-component connection structure 1 is assembled according to an embodiment of the present invention. FIG. 2 is a top view of the LED lighting unit 100 with an electric-wire holding part 120 in FIG. 1 removed. FIG. 3 is a cross-sectional view of the LED lighting unit 100 shown in FIG. 2 as taken along line A-A. FIG. 4 is a cross-sectional view of the LED lighting unit 100 shown in FIG. 2 as taken along line B-B. FIG. 5 is a bottom view of the electronic-component connection structure 1 shown in FIG. 1. FIG. 6 is an enlarged perspective view of a housing 10 shown in FIG. 1. FIG. 7 is a cross-sectional view illustrating a portion of the housing 10 shown in FIG. 6. FIG. 8 is an enlarged perspective view of a terminal 20 shown in FIG. 1. FIG. 9 is a diagram for explaining details of the electric-wire holding part 120 shown in FIG. 1. FIG. 10 is a circuit diagram illustrating a circuit configuration of the LED lighting unit 100 shown in FIG. 1.

In FIGS. 1 to 10, for convenience, arrow directions are defined as a front side, a rear side, an upper side, and a lower (down) side.

The LED lighting unit 100 having the electronic-component connection structure 1 according to the embodiment of the present invention performs light irradiation of an LED element L by electrically connecting different electric wires with a pair of terminals 20, respectively. The LED lighting unit 100, as an electronic-component connection unit, includes a unit housing 110, the electronic-component connection structure 1, and the electric-wire holding part 120, as shown in FIG. 1.

First, the unit housing 110 will be described. The unit housing 110 accommodates the electronic-component connection structure 1 and the electric-wire holding part 120. The unit housing 110 is a box-shaped casing having an opening 110a serving as an insertion opening for accommodating the electronic-component connection structure 1 and the electric-wire holding part 120 within the unit housing 110. Inside the unit housing 110, the electronic-component connection structure 1 and the electric-wire holding part 120 are disposed in the order of the electronic-component connection structure 1 and the electric-wire holding part 120 from the front side. Further, the unit housing 110 includes an opening 111 for illumination and an opening 112 for engagement.

The opening 111 for illumination is an opening formed at a wall forming an upper face of the unit housing 110, and is for emitting light emitted from the LED element L accommodated within the unit housing 110 toward the outside. The opening 111 for illumination may have a structure for enabling a light transmissive member such as a lens to be used as a lid.

The opening 112 for engagement is an opening formed at a side wall of the unit housing 110 in the vicinity of the opening 110a. The opening 112 for engagement, which corresponds to an engagement portion, is engaged with a lance portion 122 (to be described below) of the electric-wire holding part 120. In other words, the opening 112 for engagement can be engaged with the lance portion 122 so as to fix the electronic-component connection structure 1 and the electric-wire holding part 120 within the unit housing 110.

Next, the electronic-component connection structure 1 will be described. The electronic-component connection structure 1 includes the housing 10, and a pair of terminals 20 that is accommodated within the housing 10. The electronic-component connection structure 1 is for electrically connecting electronic components accommodated inside the housing 10 by the pair of terminals 20 fixed within the housing 10. In other words, the electronic-component connection structure 1 electrically connects the LED element L, a Zener diode D, and a resistor R as electronic components, and accommodates the LED element L, the Zener diode D, and the resistive plate R within the housing 10. In a case where the electronic-component connection structure 1 is accommodated within the unit housing 110, as shown in FIG. 3, the LED element L is disposed at a position corresponding to the opening 111 for illumination, and press-contact terminal portions 23b (to be described below) to be connected with individual electric wires W are directed toward the opening 110a of the unit housing 110.

The housing 10 is a box-shaped casing which is made of an insulating material to have an opening 10a at the upper face thereof. The housing 10 includes a rectangular bottom wall 11 and side walls including a front wall 12, a rear wall 13, and a pair of right and left walls 14 provided to stand from four sides of the bottom wall 11, as shown in FIGS. 5 to 7. The rear wall 13 faces the front wall 12, and the pair of right and left walls 14 faces each other. Further, the housing 10 includes an LED-element insertion opening 12a, a Zener-diode insertion opening 12b, a resistive-plate insertion opening 11a, a separation wall 15, and a terminal-fixing part 16.

The LED-element insertion opening 12a is an opening formed at the front wall 12 for inserting the LED element L into the housing 10.

The Zener-diode insertion opening 12b is an opening formed at the front wall 12 for inserting the Zener diode D into the housing 10.

The resistive-plate insertion opening 11a is an opening formed at the bottom wall 11 for inserting the resistive plate R into the housing 10.

The separation wall 15 is a wall which is provided at a position between the right and left walls 14 facing each other to stand from the bottom wall 11 in parallel with the right and left walls 14 and divides the accommodation space in the housing 10 into two accommodation spaces almost equal to each other. The two accommodation spaces in the housing 10 accommodate corresponding terminals 20. Therefore, the terminals 20 are accommodated within the housing 10 while maintaining an insulation state without being in contact with each other.

In a wall surface of the separation wall 15 and a side surface of the right and left walls 14 facing the corresponding wall surface of the separation wall 15, a pair of straight grooves 15a is formed in a vertical direction, and functions as a guide for disposing the resistive plate R at a connection position of a corresponding terminal 20 in the housing 10.

Further, at positions of a front end portion of the separation wall 15 corresponding to the LED-element insertion opening 12a and the Zener-diode insertion opening 12b, notch portions 15b are formed to allow the LED element L and the Zener diode D to be accommodated within the housing 10.

The terminal-fixing part 16 is formed to protrude from a wall surface 15c of the separation wall 15 as shown in FIG. 3, and clamps the terminals 20 in cooperation with the bottom wall 11 of the housing 10 so as to fix each terminal 20 in the housing 10.

Next, the pair of terminals 20 will be described.

The pair of terminals 20 includes two terminals being the same in shape. The pair of terminals 20 is arranged within the housing 10 so that end parts (second ends) 20d in which the press-contact terminal portions 23b described later are aligned in parallel (side by side), and end parts (first ends) 20c opposite to the end parts 20d are aligned in parallel (side by side). Further, the pair of terminals 20 is accommodated in the housing 10 so that the press-contact terminal portions 23b are exposed and extended outside the housing 10 through an opening part 10a, and provided perpendicularly from an outer surface 13e of the rear wall 13 of the housing 10.

Each terminal 20 of the pair of terminals 20 is formed integrally by a pressing work on a conductive plate-shaped member. As shown in FIG. 8, each terminal 20 includes a first component-connection portion 21 and a second component-connection portion 22 formed by bending both longitudinal sides of a rectangular top board portion 20a downward, and an electric-wire connection portion 23 formed by bending a rear end portion of the top board portion 20a downward and then bending the rear end portion toward the rear side. The top board portion 20a includes a pair of bent edge portions 20b formed by bending both edges, forming the both longitudinal edges of the top board portion 20a, downward.

The first component-connection portion 21 includes a pair of base portions 21a provided to stand from both edge of the top board portion 20a, a pair of protrusion pieces 21b extending from lower edges of the base portions 21a toward the front side (in a lateral direction), and a pair of first contact pieces 21c and a pair of second contact pieces 21d protruding from the base portions 21a between the top board portion 20a and the pair of protrusion pieces 21b toward the front side (in the lateral direction).

The pair of first contact pieces 21c extends toward end portions 21cc to shorten distances from the top board portion 20a. The pair of first contact pieces 21c has elasticity.

The pair of second contact pieces 21d is formed below the pair of first contact pieces 21c to extend toward end portions 21dd such that distances from the protrusion pieces 21b are shortened. The pair of second contact pieces also has elasticity.

Each first contact piece 21c having this structure includes an LED-element connection portion 24 to be electrically connected with the LED element L, and a Zener-diode connection portion 25 to be electrically connected with the Zener diode D.

The LED-element connection portion 24 clamps the LED element L by the pair of bent edge portions 20b of the top board portion 20a and the pair of first contact pieces 21c. In other words, the LED element L is inserted between the pair of bent edge portions 20b and the pair of first contact pieces 21c, such that the LED element L is clamped by the elasticity of the pair of first contact pieces 21c, and the pair of terminals 20 and the LED element L are electrically connected.

The Zener-diode connection portion 25 clamps the Zener diode D by the pair of protrusion pieces 21b and the pair of second contact pieces 21d. In other words, the Zener diode D is inserted between the pair of protrusion pieces 21b and the pair of second contact pieces 21d, such that the Zener diode D is clamped by the elasticity of the pair of second contact pieces 21d and the pair of terminals 20 and the Zener diode D are electrically connected.

The second component-connection portion 22 includes a pair of base portions 21a, and a pair of engagement portions 22a and a pair of third contact pieces 22d provided to stand from both edges of the top board portion 20a.

The pair of engagement portions 22a includes main end surface portions 22b and hook-like portions 22c.

The main end surface portions 22b have end surfaces formed to extend vertically. In a case where the terminals 20 are accommodated within the housing 10, the main end surface portions 22b are brought into surface-contact with an inner surface of the rear wall 13 as shown in FIG. 3.

The hook-like portions 22c are portions formed in a hook shape at lower portions of the engagement portions 22a. In the case where the terminals 20 are accommodated within the housing 10, the hook-like portions 22c are engaged with an inner-surface-side step 13a formed on the inner surface side of the rear wall 13, as shown in FIG. 3.

The pair of third contact pieces 22d is a pair of elastic pieces extending from the top board portion 20a between the pair of base portions 21a and the pair of engagement portions 22a downward, as shown in FIG. 8. The pair of third contact pieces 22d extends toward the end portions to shorten distances from the pair of base portions 21a.

The second component-connection portion 22 having the above-mentioned structure includes a resistive-plate connection portion 26 to be electrically connected with the resistive plate R.

The resistive-plate connection portion 26 clamps the resistive plate R by the pair of base portions 21a and the pair of third contact pieces 22d. In other words, the resistive plate R is inserted between the pair of base portions 21a and the pair of third contact pieces 22d, such that the resistive plate R is clamped by the elasticity of the pair of third contact pieces 22d and the terminals 20 and the resistive plate R are electrically connected.

The electric-wire connection portion 23 includes a wall-surface contact portion 23a and a press-contact terminal portion 23b. The wall-surface contact portion 23a is a portion formed by bending the top board portion 20a downward. The wall-surface contact portion 23a is formed in a bent shape along an outer surface including an upper end surface of the rear wall 13 when the terminals 20 are accommodated within the housing 10, as shown in FIG. 3.

The press-contact terminal portion 23b is a plate-shaped portion formed by bending from the downwardly-bent wall-surface contact portion 23a toward the rear side, as shown in FIG. 8. The press-contact terminal portion 23b has a notch 23c formed in a U shape. When the electric wire W is pressed into the notch 23c, the electric wire W and the terminals 20 are electrically connected.

The pair of terminals 20 is formed so that a surface 23d on which the notch 23c of the press-contact terminal portion 23b is formed is placed in parallel to a surface (a placement surface) 11b of the bottom wall 11 of the housing on which the pair of terminals 20 is placed. In this way, since the surface 23d on which the notch 23c is formed is in parallel to the surface lib of the bottom wall 11, even when respective electric wires W are press-fitted to the pair of terminals 20, one press-contact terminal portion 23b does not interfere with the electric wire W connected to the other press-contact terminal portion 23b.

A bent portion serving as a boundary between the wall-surface contact portion 23a and the press-contact terminal portion 23b is formed to be engaged with an outer-surface-side step 13b formed at the rear wall 13, as shown in FIG. 3. Therefore, the terminals 20 clamp the rear wall 13 by the wall-surface contact portion 23a and the pair of engagement portions 22a.

Next, the electric-wire holding part 120 will be described.

The electric-wire holding part 120 holds a bent portion of each electric wire W formed by turning each electric wire W back, and is accommodated within the unit housing 110 in that state, as shown by (a) to (b) in FIG. 9, so as to electrically connect each electric wire W to each terminal 20 in the unit housing 110.

The electric-wire holding part 120 holds two electric wires W to be electrically connected to each terminal 20 of the pair of terminals 20. Further, the electric-wire holding part 120 includes a bend-holding portion 121 and the lance portion 122.

The bend-holding portion 121 is for holding the bent portion of each electric wire W formed by turning each electric wire W back. The bend-holding portion 121 is formed to be inserted into the unit housing 110 up to a position at which the bent portion of each electric wire W is brought into contact with each press-contact terminal portion 23b by pressurizing. Further, the bend-holding portion 121 includes notches 121a formed at the front end portion such that the press-contact terminal portions 23b are connected to the electric wires W.

The lance portion 122 is engaged, as the engagement portion, with engagement openings 112 formed at the unit housing 110 so as to fix the electric-wire holding part 120 within the unit housing 110.

When the electric-wire holding part 120 bends and holds each electric wire W, and then is accommodated within the unit housing 110, that is, when the electric-wire holding part 120 and the unit housing 110 are engaged with each other by the engagement portions 112, 122, the bent portions of the electric wires W held by the electric-wire holding part 120 are electrically connected to the pair of press-contact terminal portions 23b, respectively.

The LED lighting unit 100 having the above-mentioned configuration is configured by connecting the LED element L and the Zener diode D in parallel as shown in FIG. 10, such that the LED element L is protected from an over-voltage.

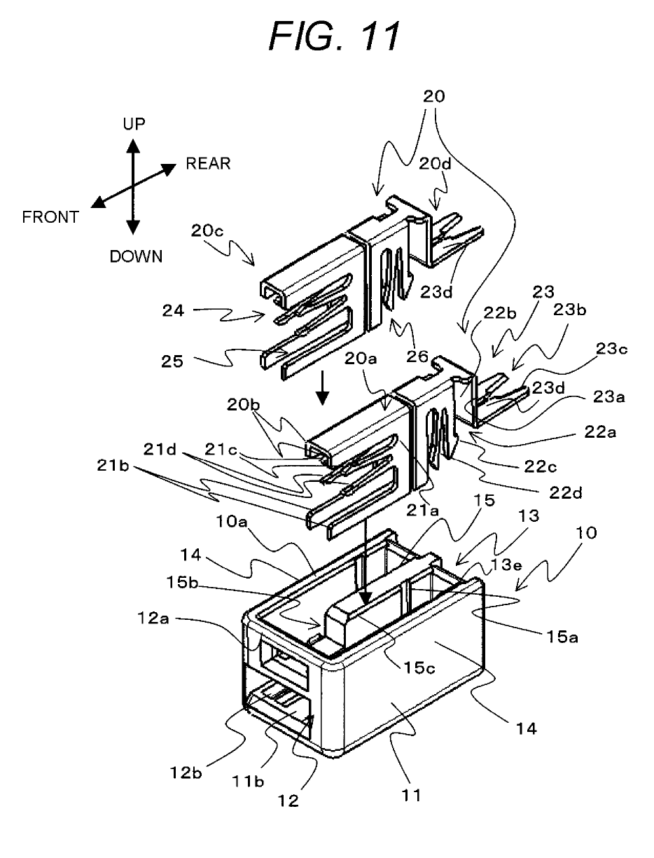

Next, an assembly procedure of the LED lighting unit 100 in which the electronic-component connection structure 1 is assembled according to the embodiment of the present invention will be described with reference to FIGS. 11 to 15. FIGS. 11 to 15 are diagrams for illustrating an assembly procedure of the LED lighting unit 100 in which the electronic-component connection structure 1 is to be assembled according to the embodiment of the present invention.

First, a worker accommodates the pair of terminals 20 within the housing 10, as shown in FIG. 11. At this time, each terminal 20 is inserted from the opening 10a of the housing 10. In this case, each terminal 20 is fixed in the housing 10 such that the protrusion pieces 21b are positioned between the lower end surface 16b of the terminal-fixing part 16 and the upper surface of the bottom wall 11. The pair of terminals 20 is arranged so that the surfaces 23d on which the notches 23c are formed are placed in parallel to the surface lib of the bottom wall 11.

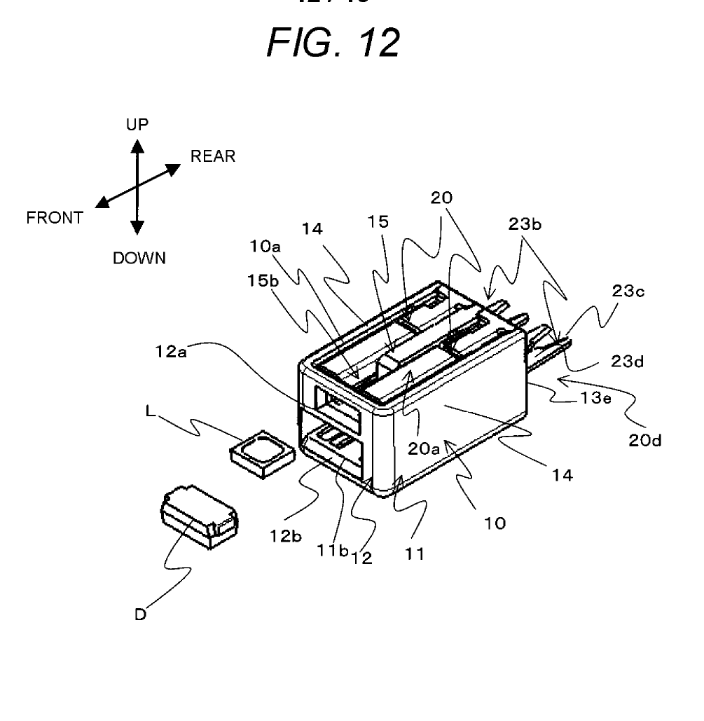

Then, the worker connects the LED element L and the Zener diode D to the pair of terminals 20 as shown in FIG. 12. More specifically, the LED element L is inserted from the LED-element insertion opening 12a into the housing 10, and is disposed between the pair of bent edge portions 20b and the pair of the first contact pieces 21c. At this time, the LED element L is inserted while widening gaps between the pair of bent edge portions 20b and the pair of first contact pieces 21c by using the elasticity of the pair of first contact pieces 21c. Therefore, a biasing force is applied toward the pair of bent edge portions 20b by the pair of first contact pieces 21c, such that the LED element L is held between the pair of bent edge portions 20b and the pair of first contact pieces 21c, as shown in FIG. 3.

The Zener diode D is inserted from the Zener-diode insertion opening 12b, and is disposed between the pair of protrusion pieces 21b and the pair of second contact pieces 21d. At this time, the Zener diode D is inserted while widening gaps between the pair of protrusion pieces 21b and the pair of second contact pieces 21d by using the elasticity of the pair of second contact pieces 21d. Therefore, a biasing force is applied toward the pair of protrusion pieces 21b by the pair of second contact pieces 21d, such that the Zener diode D is held between the pair of protrusion pieces 21b and the pair of second contact pieces 21d, as shown in FIG. 3.

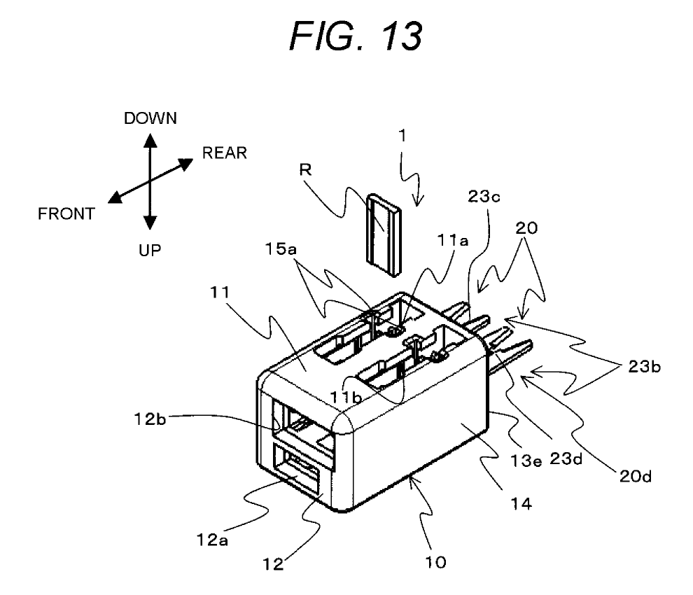

Next, the worker connects the resistive plate R to the pair of terminals 20 as shown in FIG. 13. At this time, the resistive plate R is inserted from the resistive-plate insertion opening 11a into the housing 10 while being guided by the pair of grooves 15a, and is disposed between the pair of base portions 21a and the pair of third contact pieces 22d. Further, the resistive plate R is inserted while widening gaps between the base portions 21a and the pair of third contact pieces 22d by using the elasticity of the pair of third contact pieces 22d. Therefore, a biasing force is applied toward the pair of base portions 21a by the pair of third contact pieces 22d, such that the resistive plate R is held between the pair of base portions 21a and the pair of third contact pieces 22d, as shown in FIG. 3.

By the above-mentioned assembly work, the electronic-component connection structure 1 is completed.

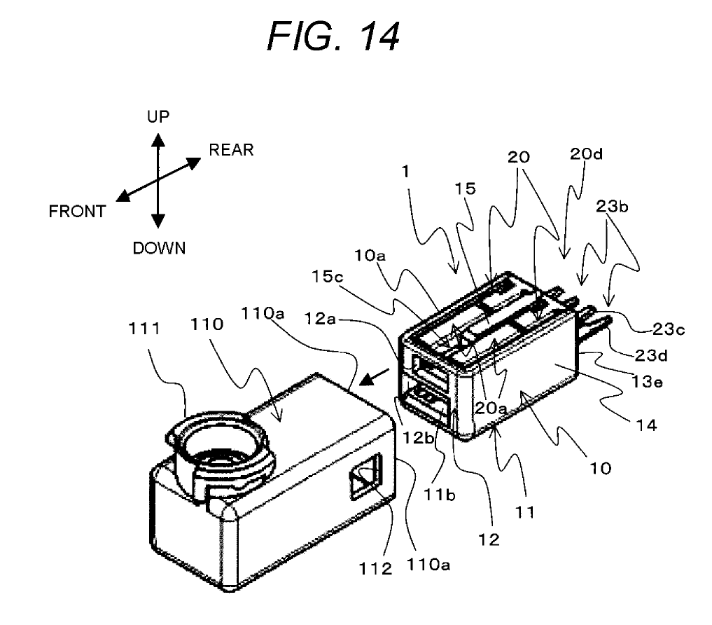

Next, the worker accommodates the electronic-component connection structure 1 within the unit housing 110 as shown in FIG. 14. Therefore, the LED element L is disposed at a position corresponding to the opening 111 for illumination of the unit housing 110. Further, the press-contact terminal portions 23b of the pair of terminals 20 are disposed toward the opening 110a side of the unit housing 110.

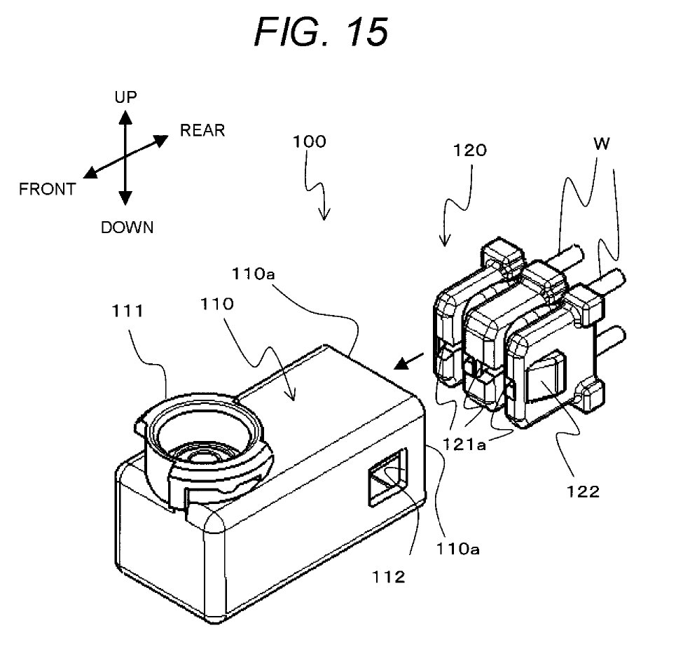

Next, the worker accommodates the electric-wire holding part 120 within the unit housing 110 as shown in FIG. 15. In this way, the LED lighting unit 100 is completed. When the electric-wire holding part 120 is pressed from the opening 110a of the unit housing 110 up to a predetermined position in the unit housing 110, each electric wire W is pressed into the notch 23c of each press-contact terminal portion 23b, such that each electric wire W and a corresponding terminal 20 are electrically connected. As described above, since the lance portions 122 are engaged with the engagement openings 112 of the unit housing 110 with each electric wire W and a corresponding terminal 20 electrically connected, the electric-wire holding parts 120 are fixed in the unit housing 110 in a state in which the connection of each electric wire W and a corresponding terminal 20 is maintained.

According to the electronic-component connection structure 1 in the embodiment of the present invention, since the pair of terminals 20 corresponds to the same shaped two terminals 20 in which the surface 23d in which the notch 23c is formed extends in parallel to the surface lib of the bottom wall 11 of the housing 10, even if the press-contact terminals portions 23b are arranged side by side and the respective electric wires W are press-fitted in the pair of terminals 20, one of the press-contact terminals 20 does not interfere with the electric wire W connected to the other of the press-contact terminals 20. Therefore, it is possible to unify the shape of the pair of terminals 20, thereby reducing the manufacturing cost.

Further, according to the electronic-component connection structure 1 in the embodiment of the present invention, the pair of terminals 20 is arranged within the housing 10 so that the ends 20d of the pair of terminals 20 in which the press-contact terminal portions 23b are formed are aligned in parallel to each other and the ends 20c of the pair of terminals 20 opposite to the ends 20d in which the press-contact terminal portions 23b are formed are aligned in parallel to each other, that is, the pair of terminals 20 are arranged so that their opposite ends are aligned. Therefore, it is possible to arrange the pair of terminals 20 compactly.

Further, according to the LED lighting unit 100 in the embodiment of the present invention, the LED lighting unit 100 includes a unit housing 110 having a box shape which is open on one surface 110a from which the connection structure 1 is accommodated inside the unit housing 110. Further, an opening portion 10a is formed on an upper surface of the housing 10, the press-contact terminal portion 23b of each terminal 20 of the pair of terminals 20 is exposed and extended outside the housing 10 through the opening portion 10a of the housing 10 and provided perpendicularly from an outer surface 13e of the rear wall 13 of the housing 10, and the press-contact terminal portion 23b of each terminal 20 of the pair of terminals 20 is arranged at a side of the one surface on which the unit housing 110 is open (at the opening 110a side) when the connection structure 1 is accommodated in the unit housing 110. Therefore, it is possible to accommodate the pair of terminals 20 within the housing 10 and the unit housing 110 easily while the press-contact terminal portion 23b is exposed.

Further, according to the LED lighting unit 100 in the embodiment of the present invention, the LED lighting unit 100 further includes an electric-wire holding part 120 in which two electric wires W to be electrically connected to the pair of terminals 20 are laterally bent and held, and an engagement portion having the opening 112 for engagement and the lance portion 122 which engages the unit housing 110 with the electric-wire holding part 120. Bent portions of the two electric wires W which are held by the electric-wire holding part 120 are electrically connected to the respective press-contact terminal portions 23b of the pair of terminals 20 when the unit housing 110 and the electric-wire holding part 120 are engaged by the opening 112 for engagement and the lance portion 122. Therefore, since the electric wires W are connected to the respective press-contact terminal portions 23b while the electric wires W are laterally bent, it is possible to save the space of the LED lighting unit 100 in the vertical direction.

In the electronic-component connection structure 1 according to the embodiment of the present invention, one pair of terminals 20 is used. However, the present invention is not limited thereto. In other words, two or more terminals to be electrically connected to electronic components may be provided.

In the electronic-component connection structure 1 according to the embodiment of the present invention, each terminal 20 is formed by pressing on the plate-shaped member. However, the present invention is not limited thereto. In other words, each terminal may include a base portion 21a, a protrusion piece 21b or a top board portion 20a extending from the base portion 21a in a lateral direction, and a contact piece which extends in the lateral direction such that a distance from the protrusion piece 21b or the top board portion 20a decreases from the base portion 21a toward an end portion, and has elasticity.

In the electronic-component connection structure 1 according to the embodiment of the present invention, as the electronic components, the LED element L, the Zener diode D, and the resistive plate R are electrically connected to the pair of terminals 20. However, the present invention is not limited thereto. In other words, other electronic components may be connected to the pair of terminals 20.

The present invention is not limited by the embodiment and the modification as mentioned above.

What is claimed is:

1. A connection structure, comprising:
a box-shaped housing having a bottom wall and side walls which extend from the bottom wall;
an electronic component which is accommodated inside the housing; and
a pair of terminals, being the same in shape, which are inserted into the housing vertically along planes of two side walls which face each other among the side walls and placed on a placement surface of the bottom wall to be fixed inside the housing, each terminal of the pair of terminals including:
a component-connection portion which is formed at a first end of the terminal to be electrically connected to the electronic component; and
a press-contact terminal portion which is formed at a second end opposite to the first end of the terminal and which has a notch to which an electric wire is to be press-fitted and electrically connected, wherein a surface in which the notch is formed extends in parallel to the placement surface of the bottom wall of the housing.

2. The connection structure according to claim 1, wherein
the pair of terminals is arranged within the housing so that the first ends of the pair of terminals are aligned in parallel to each other and the second ends of the pair of terminals are aligned in parallel to each other.

3. A connection unit in which the connection structure as defined in claim 1 is assembled, the connection unit comprising:
a unit housing having a box shape which is open on one surface from which the connection structure is accommodated inside the unit housing, wherein
an opening portion is formed on an upper surface of the housing,
the press-contact terminal portion of each terminal of the pair of terminals is exposed and extended outside the housing through the opening portion of the housing and provided perpendicularly from an outer surface of one of the side walls of the housing, and
the press-contact terminal portion of each terminal of the pair of terminals is arranged at a side of the one surface on which the unit housing is open when the connection structure is accommodated in the unit housing.

4. The connection unit according to claim 3, further comprising:
an electric-wire holding part in which two electric wires to be electrically connected to the pair of terminals are laterally bent and held;
an engagement portion which engages the unit housing with the electric-wire holding part, wherein
bent portions of the two electric wires which are held by the electric-wire holding part are electrically connected to the respective press-contact terminal portions of the pair of terminals when the unit housing and the electric-wire holding part are engaged by the engagement portion.
